(19) United States
(12) Patent Application Publication
(10) Pub. No.: US 2006/0249916 A1
(43) Pub. Date: Nov. 9, 2006

(54) Cylinder head seal

(76) Inventor: Christoph Hilgert, Overath (DE)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/418,332

(22) Filed: May 4, 2006

(30) Foreign Application Priority Data
May 4, 2005 (DE) 10 2005 020 923.8

(51) Int. Cl. F02F 11/00

(52) U.S. Cl. 277/595

(57) ABSTRACT

Multi-layered flat seal, in particular a cylinder head seal for an internal combustion engine, with a first layer having at least a passage opening as well as several screw passage punch holes, at least a support ring surrounding the passage opening, and at least a second layer, which at least is provided with a bead of partially circular form, whereby the bead interacts cooperatively with the support ring and, viewed in circumferential direction, is formed by mechanical shaping with areas of different spring stiffness.

### RELATED APPLICATIONS

This application claims priority to German Patent Application No. 10 2005 020 923.8, filed May 4, 2005.

### BACKGROUND OF THE INVENTION

1. Technical Field

This invention relates to a multi-layered seal, in particular a cylinder head seal for an internal combustion engine.

2. Related Art

A metallic flat seal, in particular a cylinder head seal, has become known through U.S. Pat. No. 5,628,518, which has several layers and with which at least one support ring can be introduced around the combustion chamber passage opening. The layers of the cylinder head seal are provided with beads, whereby the beads interact co-operatively with the support ring. The beads are formed here of uniform cross-section in the circumferential direction.

EP-B 0 306 766 is taken from a similar flat seal of the aforementioned US patent, in which the support ring can exhibit different cross-sectional forms.

In EP-A 0 863 335 a metallic flat seal, in particular a cylinder head seal, is described, which has at least a crescent or fold deformation in the area of a passage opening, whereby the metallic flat seal serves for the sealing of flat components. The seal should have topographically distributed zones of different hardness at different points and also zones with different mechanical properties, which extend over all or part of the cross-section of the sealing layer. For the attainment of different hardnesses, the crescent or fold deformations are thermally treated at different points, so that topographically distributed zones in the metal layer having different texture formation are generated. This requires an expense which is not insignificant.

The different rigidities of the flanges and the finite number of screws naturally leads to deformation of the sealing surface. The corresponding prior art seals adjust themselves to undesirable sealing pressures, but the manufacturing cost is elevated. Such measures are undesirable since the seal system must always be constructed with the weakest member in mind.

### SUMMARY OF THE INVENTION AND ADVANTAGES

The object of the invention is to improve or, respectively, to manufacture by use of simple means, a flat seal such as that described by way of example in U.S. Pat. No. 5,628,518, in particular a cylinder head seal, to the effect that in the area of the combustion chamber passage opening in each case a uniform pressure with reduced screw force is obtained.

This problem is solved by means of a multi-layer flat seal, in particular a cylinder head seal for an internal combustion engine, with a first layer having at least a passage opening and also several screw passage punch holes, at least a support ring surrounding the passage opening, and at least a second layer, which is at least provided with a bead of partially circular form, whereby the bead interacts cooperatively with the support ring and, viewed in circumferential direction, is formed with regions of different spring stiffness by mechanical shaping.

EP-A 0 863 335 already solves a partial problem, namely areas with different texture structure are produced by use of expensive heat treatment, and so in contrast thereto, the subject matter of the invention represents a substantially simpler process, and with a support ring as well.

In those areas in which a high pressure naturally forms, for example in the area of the screws, the bead is formed less rigid. In contrast, beads in areas in which a lower pressure is applied, for example between the screws, are shaped more rigid. The rigidity of the bead can be brought about through different measures.

Through distribution of the beads, decrease of the bead height, or bead side leg flattening, the beads are engineered with less rigidity.

By reduction of the width, increase of the bead height, or use of a steeper bead side leg, the bead is made more rigid.

Combinations of these measures are also conceivable.

In such manner, beads adjusted to the particular conditions of operation lead to a uniform pressure around the passage opening and, respectively, the combustion chamber passage opening and thus use less of the available screw strength. This in turn has a positive influence on the durability of the seal connection and leads to a minor distortion of the contiguous walls.

### THE DRAWINGS

The subject matter of the invention is represented in the drawings by means of a example embodiment and is described as follows:

FIG. 1 illustrates a multi-layered flat seal formed as a cylinder head seal; and

FIGS. 2 to 5 illustrate various cross sections of the flat seal of FIG. 1.

### DETAILED DESCRIPTION

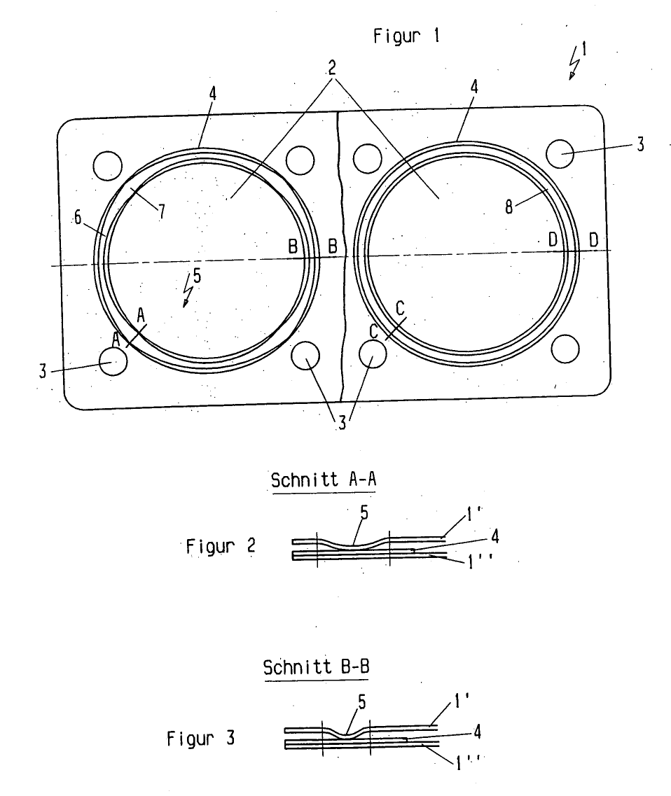

FIG. 1 shows in the top view as a cylinder head seal for an internal combustion engine an insertable multi-layered seal 1, containing several combustion chamber passage opening component passage openings 2 as well as equivalent surrounding screw punch holes 3. In the left section of the flat seal it is recognizable that a support ring 4 is provided, upon which a bead 5 of another layer is overlaid, wherein the bead 5 contains areas 6,7 of different width.

In the right section of FIG. 1 a support ring 4 is likewise provided, upon which a bead 8 is overlaid, which has equal broad portions in the circumferential direction, but different heights (not shown here).

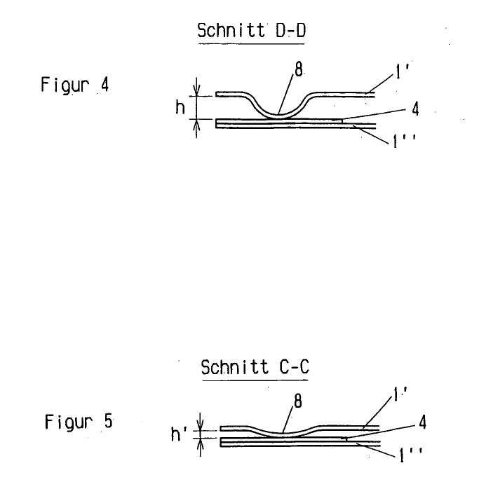

FIGS. 2 and 3 show sections through the left part of flat seal 1. Recognizable are two layers 1″, 1″ as well as the support ring 4. The section according to line A-A through FIG. 1 shows an area in which the bead 5 is shaped more broadly 7 than as is the case with the section corresponding to line B-B. By this technique the areas 6, 7 of different spring stiffness already mentioned in FIG. 1 can be formed in the circumferential direction. Bead 5 exhibits in the area of the screw passage holes a wider area 7 and thus is less rigid in construction. Between the screw passage holes 3 the bead 5 is more narrow at 6, which leads to an increase of the rigidity.

The variant according to the right section of the flat seal 1 exhibits differently shaped beads 8 in sections C-C, D-D, which here remain essentially equal of width, viewed over the circumference. Also, layers 1′, 1″ as well as the support ring 4 are specified.

By means of the technical solutions shown in the right and left halves of FIG. 1 uniform pressures can be maintained around the combustion chamber opening 2, whereby less of the available screw strength is required.

What is claimed is:

1. A multi-layered flat seal comprising:
a first layer having at least a passage opening and a plurality of screw passage punch holes, at least one support ring surrounding the passage opening, and at least a second layer provided with a beard of partially circular form, whereby the bead interacts cooperatively with the support ring and, viewed in circumferential direction, is formed by mechanical shaping with regions of different spring stiffness.

2. Flat seal according to claim 1, wherein the bead is a full bead.

3. Flat seal according to claim 2, wherein a convex area of the full bead overlays the support ring.

4. Flat seal according to claim 1, wherein the bead has a region associated with a higher pressure area that is formed to be relatively less rigid and a region associated with a surrounding area of lower pressure that is formed to be relatively more rigid.

5. Flat seal according to claim 1, wherein through spreading of the bead, decrease of the bead height or flattening the bead side leg, a lower rigidity of the bead is adjustable.

6. Flat seal according to claim 1 wherein through reduction of the width of bead, increase of the bead height or a steeper bead side leg, a greater rigidity of the bead is adjustable.

7. Flat seal according to claim 5, wherein a combination of the parameters act to influence the rigidity of the bead.
